(19) United States
(12) Patent Application Publication
(10) Pub. No.: US 2005/0271190 A1
(43) Pub. Date: Dec. 8, 2005

(54) Telephone disconnect control

(76) Inventor: Thomas Ellen Linkenhoger, Tampa, FL (US)

Correspondence Address: THOMAS E. LINKENHOGER, 13516 WEST HILLSBOROUGH AVENUE, LOT 49A, TAMPA, FL, 33635, US

(21) Appl. No.: 10/862,668

(22) Filed: Jun. 7, 2004

(51) Int. Cl. H04M 11/00

(52) U.S. Cl. 379/93.05; 379/102.02

(57) ABSTRACT

The present invention provides a telephone user a convenient means of temporarily disconnecting their telephone line to avoid unwanted distraction by the telephone when the need arises. It may also be used for security against unauthorized use of the telephone. It does this manually by the user operating a switch on the control to turn the telephone line ‘off’ and ‘on’. The switch operates a relay within the control which is connected to the telephone line coming from the telephone company. The control is designed to receive a common small appliance automatic timer which can be plugged directly into the control housing. The timer is supplied by the user which allows the disconnect control to be used in automatic as well as manual mode. The control will not disturb a telephone base power supply because only the telephone line from the phone company is connected to the disconnect control. This invention does not apply to cell phones.

### BACKGROUND OF THE INVENTION

Although the telephone is a great convenience it is also a form of home invasion and some people wish they had some manner of control of the telephone when they are in need of privacy and want to avoid unnecessary distraction by the telephone. Some people may feel they are at the mercy of the telephone because they do not have any means of controlling the situation without manually disabling two or three functions of the telephone base control which is not acceptable to many people.

### SUMMARY OF THE INVENTION

The Telephone Disconnect Control is a communications accessory device that allows the telephone user to temporarily disconnect their telephone line when in need of privacy and wants to avoid unnecessary distraction of the telephone ringing, voice of the answering machine etc. without having to manually disable these functions when the need arises.

The object and function of the present invention is to minimize if not eliminate the time and effort required by the user to assure temporary privacy from the telephone at any time without the inconvenience of disconnecting the telephone functions manually.

The present invention may also be used to provide security against unauthorized use of the telephone automatically or manually at any time during a 24 hour period.

This invention does not apply to cell phones.

### DISCRIPTION OF THE RELATED ART

To my knowledge the only telephone line disconnect device that has ever been available at telephone accessory stores was a standard telephone line connecter block where by the line from the telephone company and telephone base were connected together. A toggle switch was installed on the connector block that could be used by the telephone user to disconnect the telephone line from the telephone and of course this was a manual ‘on’ and ‘off’ operation. At one time this device was available at ‘Radio Shack’. I do not believe it is available at this time.

Apparently the only option available for disconnecting a telephone line at the present time is to directly remove the telephone line from the telephone base such as with standard telephones or manually disable the various functions at the telephone base such as with cordless handset telephones. It would seem the average person is reluctant to do this. Therefore I believe there is a need for a telephone disconnect device because the average person is not inclined to perform these manual disconnect operations but would consider having a device that would do these functions for them automatically or if they so choose manually.

### DETAILED DESCRIPTION OF THE DRAWINGS

Drawing # 1: Is a condensed electrical schematic of the disconnect control and shows the connections if used with a small appliance timer plugged into the control for automatic mode.

Drawing # 2: A drawing of the present invention as it would be presented to the user and ready for manual operation when the control power cord is connected to a 120 vac outlet and the telephone line is plugged into the telephone jacks on the disconnect control and external wiring connections.

Drawing # 3 : A illustration of the disconnect control with a 120 vac small appliance timer plugged into the control enclosure and connected for automatic mode. The telephone line is plugged into the jacks on the cover plate underneath the timer.

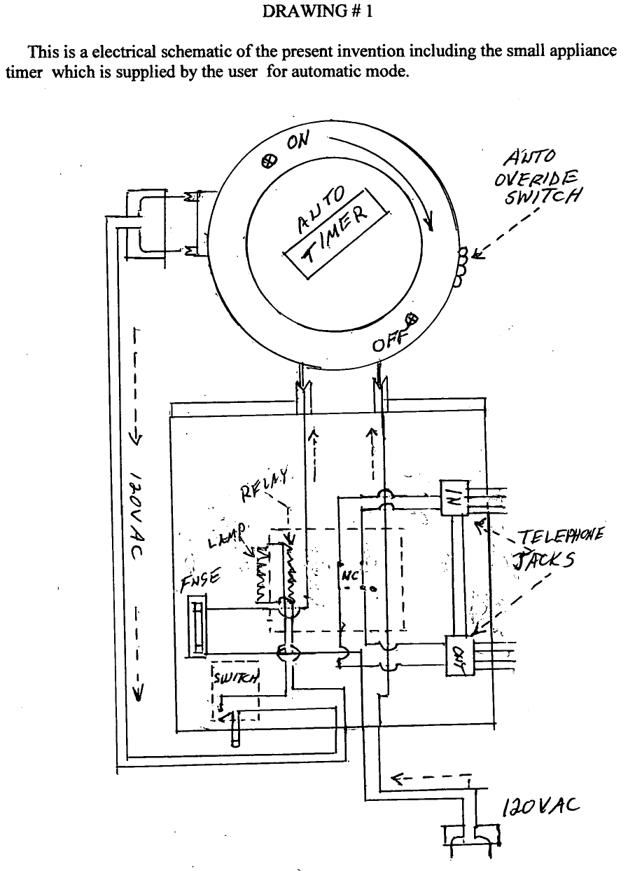

Drawing # 4: A drawing of the control enclosure showing the cover plate removed from the top of the enclosure. The cover plate holds the two telephone jacks the telephone line would plug into and the timer receptacle. The ‘one gang” wiring box is the main body of the enclosure and shows the physical placement of the components inside of it. This drawing will illustrate and identify the components ( FIG. 1 thru 11) that make up the invention.

FIG. # 1: One plastic enclosure (white ) ‘Leviton’ # 43777.

FIG. 2: One six foot lamp cord (white) standard.

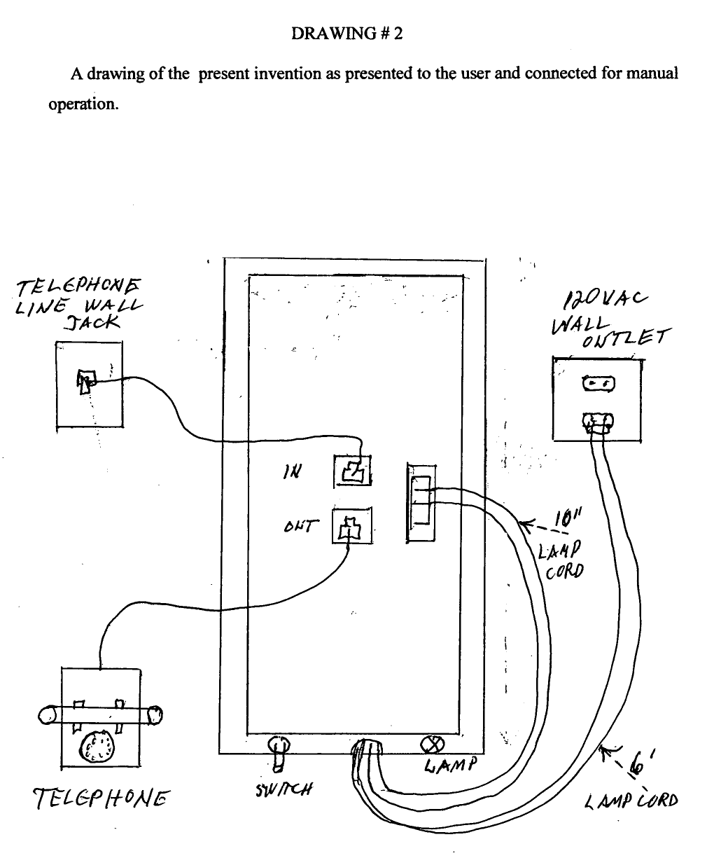

FIG. 3: One ten inch lamp cord (white) standard.

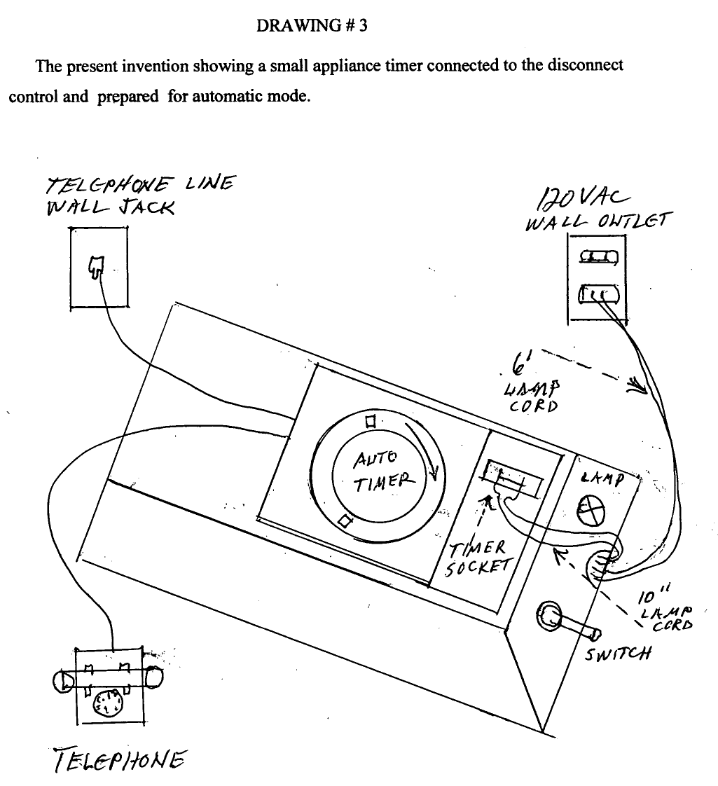

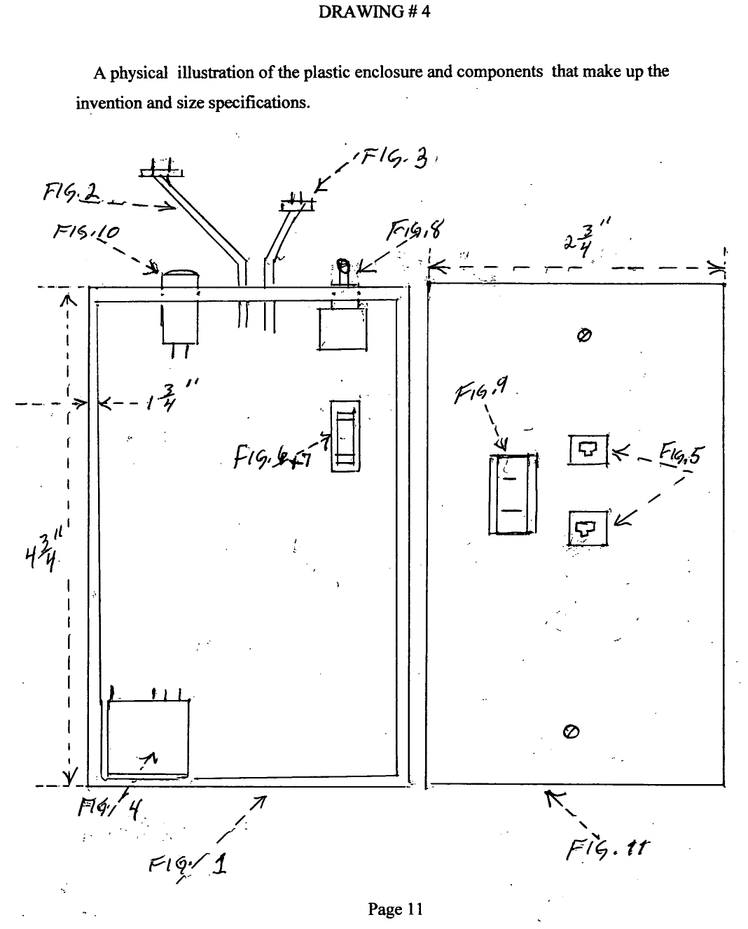

FIG. 4: One relay DPDT 120 ‘Radio Shack’ # 41106w.

FIG. # 5: Two telephone modular jacks (white) ‘Leviton’ # 41080-2-w.

FIG. 6: One fuse holder ‘Radio Shack’ # 270-739.

FIG. 7: One three amp fuse ‘Radio Shack’ # 270-1025.

FIG. 8: One toggle switch SPST ‘Radio Shack’ # 275-322.

FIG. 9; One ‘snap in’ 120 vac receptacle (white ) ‘Ace Hardware’ # 31356-704.

FIG. 10: One ‘lamp assembly’ ‘Radio Shack’ # 272-704.

FIG. 11: One ‘two port’ wall plate (white) ‘Leviton’ # 41080-2w.

### DETAILED DISCRIPTION OF THE INVENTION

The present invention is a small compact unit that provides a means of temporarily disconnecting the incoming telephone line from the telephone it services. Such as the standard telephone and cordless handset telephones that has a base which provides a number of convenient functions. This new invention does not apply to cell phones.

The invention consist of a small white plastic enclosure that has input and output telephone jacks that allow the telephone line cord to be plugged into them. The enclosure contains a relay and a toggle switch which will disconnect the telephone line if the telephone user chooses to operate the control manually. The disconnect control requires 120 vac power and therefore is capable of operating automatically if used in combination with a common small appliance timer which is provided by the telephone user. The timer will contain a auto override switch which will allow the user to use the telephone at any time without disturbing the timing sequence that has been set on the timer.

When used manually the user simply uses the toggle switch to turn the telephone line ‘off’ and ‘on’. For automatic mode the small appliance timer is plugged into the control enclosure and the timer will automatically turn the telephone ‘off’ and ‘on’ according to the timer settings. The toggle switch must be ‘on’ for automatic mode.

To set up the disconnect control for automatic mode the telephone line must be connected to the ‘in’ and ‘out’ jacks on the top cover of the control. Then the ten inch 120 vac cord must be unplugged from the 120 vac receptecle which is also on the top cover of the control. The automatic small appliance timer is then plugged into the receptacle and then the ten inch 120 vac cord which was just unplugged from the receptacle is then plugged into the timer socket which is used by the small appliance.

1. I claim as my invention a electrical device that will allow a telephone user to quickly and easily disconnect their telephone temporarily when in need of privacy and wanting to avoid unnecessary distraction from the telephone. Consisting of a small compact unit including a plastic enclosure containing a relay and toggle switch, an indicator lamp and two telephone line jacks, a fuse holder and a receptacle intended to accommodate a automatic small appliance timer and necessary wiring. Operating only on 120 vac.

2. This invention can be used according to claim 1 in manual mode as presented to the user but will also operate in automatic mode when used in combination with a common small appliance automatic timer that is supplied by the user.

3. The present invention according to claim 2 may also be used to provide security against unauthorized use of a telephone at any time during the 24 hour day by operating in either automatic or manual mode.
